(19) United States
(12) Patent Application Publication
(10) Pub. No.: US 2016/0182849 A1
(43) Pub. Date: Jun. 23, 2016

(54) WIRELESS CAMERA SYSTEM, CENTRAL DEVICE, IMAGE DISPLAY METHOD, AND IMAGE DISPLAY PROGRAM

(71) Applicant: PANASONIC INTELLECTUAL PROPERTY MANAGEMENT CO., LTD., Osaka-shi, Osaka (JP)

(72) Inventor: Satoru WAKAO, Kanagawa (JP)

(73) Assignee: PANASONIC INTELLECTUAL PROPERTY MANAGEMENT CO., LTD., Osaka-shi, Osaka (JP)

(21) Appl. No.: 14/906,962

(22) PCT Filed: Jul. 9, 2014
(86) PCT No.: PCT/JP2014/003628

§ 371 Date: Jan. 22, 2016

(30) Foreign Application Priority Data
Aug. 9, 2013 (JP) 2013-167108

(51) Int. Cl. H04N 5/44; H04L 29/06; H04N 5/232

(52) U.S. Cl. CPC H04N 5/44; H04N 5/23293; H04N 5/23245; H04L 65/80

(57) ABSTRACT

A wireless camera system includes a plurality of wireless cameras and a central device. Each of the wireless cameras includes: an image data generator configured to capture an image to generate image data; and a radio communicator configured to transmit transmission data containing the image data wirelessly. The central device includes a display configured to display configured to display the image data contained in the transmission data transmitted. A controller of the wireless cameras limits an amount of the transmission data of the wireless camera when the wireless camera is not selected by a user of the central device.

### CROSS REFERENCE TO RELATED APPLICATIONS

This application claims the benefit of Japanese Patent Application No. 2013-167108 filed on Aug. 9, 2013, the entire contents of which are hereby incorporated by reference herein.

### TECHNICAL FIELD

The present technology relates to a wireless camera system, a central device, an image display method, and an image display program, which are configured to capture images with a plurality of wireless cameras and display the captured images.

### BACKGROUND OF THE INVENTION AND RELATED ART

There has been known a wireless camera system in which a plurality of wireless cameras capture images, and a central device displays the image captured by each of the wireless cameras (e.g., JP 2011-78081 A). In the wireless camera system, each of the wireless cameras transmits the captured image to an access point by means of radio communication. The captured image is then transmitted from the access point to the central device. The central device is able either to display all images captured by a plurality of wireless cameras, or to display only the image (s) captured by one or more wireless cameras selected from the wireless cameras. In such system, devices using the same channel share a band, in radio communication. A band allocated to each device is narrowed, therefore, when a number of devices access a single access point, or when one device occupies a wide band. As a result, transmission rate is reduced.

### SUMMARY OF INVENTION

An objective of the present technology is to provide a novel wireless camera system.

According to an aspect of the wireless camera system, the wireless camera system is configured to include a plurality of wireless cameras, each of the wireless cameras including: an image data generator configured to capture an image to generate image data; a camera-side radio communicator configured to transmit transmission data containing the image data wirelessly; and a camera controller configured to control operations of the wireless camera, the wireless camera system comprising: a camera selector configured to select a part of wireless cameras from the plurality of wireless cameras; and a display configured to display the image data contained in the transmission data transmitted from the camera-side radio communicator in the wireless camera, depending on the selection made by the camera selector, wherein the wireless camera system performs a process for preventing reduction in a transmission rate for the transmission data.

According to an aspect of the central device, the central device is configured to forming, together with a plurality of wireless cameras, a wireless camera system, the central device being configured to perform a process for preventing reduction in a transmission rate for transmission data containing image data from each of the wireless cameras.

According to an aspect of the image display method, the image display method is configured to include: a capturing step configured to captures an image to generate image data by each of a plurality of wireless cameras; a transmission step configured to transmit transmission data containing the image data wirelessly from the wireless cameras; a camera selection step configured to select a part of wireless cameras among the plurality of wireless cameras; a display step configured to display the image data contained in the transmission data, depending on a selection made in the camera selection step; and a processing step configured to prevent reduction in a transmission rate for the transmission data.

According to an aspect of an image display program, the image display program is configured to cause a computer of a central device forming, together with a plurality of wireless cameras, a wireless camera system, to function as a computer which performs a process for preventing reduction in a transmission rate for transmission data containing image data from each of the wireless cameras.

By the present technology, the amount of the transmission data is limited for the wireless camera having not been selected by the central device. This enables the wireless camera having been selected to secure an available bandwidth to be used for radio transmission of the transmission data. As a result, the present technology is effective in that the transmission data is transmitted to the central device at a high transmission rate, and so on.

As described below, the present technology has other aspects. It is therefore to be understood that the disclosure of the present technology herein is described for the purpose of simply providing part of the present technology, not for the purpose of limiting the scope of the present technology described and claimed herein.

### BRIEF DESCRIPTION OF DRAWINGS

FIG. 1 is a diagram showing an example of operations of the wireless camera system in an embodiment (at the time when a camera A is selected).

FIG. 2 is a diagram showing an entire configuration of the wireless camera system in an embodiment.

FIG. 3 is a block diagram showing a configuration of a wireless camera in an embodiment.

FIG. 4 is a block diagram showing a configuration of the central device in an embodiment.

FIG. 5 is a diagram showing an example of operations of the wireless camera system in an embodiment (at the time when a camera B is selected).

FIG. 6 is a diagram showing an example of a display screen displayed by the display of the central device in an embodiment (at the time when a camera A is selected).

FIG. 7 is a diagram showing an example of display screen displayed by the display of the central device in an embodiment (at the time when a camera B is selected).

FIG. 8 is a flow diagram showing a flow of operations of the central device in an embodiment.

FIG. 9 is a diagram showing an example of display screen of the central device in an embodiment.

FIG. 10 is a diagram showing locations of a plurality of wireless cameras in Variation 7.

FIG. 11 is a diagram showing an example of display screen of the central device in Variation 7.

FIG. 12 is a diagram showing an example of display screen of the central device in Variation 7.

FIG. 13 is a diagram showing an example of display screen of the central device in Variation 7.

FIG. 14 is a diagram showing an example of an arrow in Variation 8.

FIG. 15 is a diagram showing an example of an arrow in Variation 8.

FIG. 16 is a diagram showing an example of an arrow in Variation 8.

### DETAILED DESCRIPTION

The following is a description of an embodiment of the wireless camera system. The embodiment described below is provided to show an example of implementing the present technology, but is not provided to limit the scope of the present technology to a particular configuration described later. To implement the present technology, a particular configuration specific to each embodiment may be adopted. In this document, a term “image” includes both a moving image (i.e., a video) and a still image.

A wireless camera system according to one aspect includes a plurality of wireless cameras, ach of the wireless cameras comprising: an image data generator configured to capture an image to generate image data; a camera-side radio communicator configured to transmit transmission data containing the image data wirelessly; and a camera controller configured to control operations of the wireless camera, the wireless camera system including: a camera selector configured to select a part of wireless cameras among the plurality of wireless cameras; and a display configured to display the image data contained in the transmission data transmitted from the camera-side radio communicator in the wireless camera, depending on a selection made by the camera selector, wherein the wireless camera system performs a process for preventing reduction in a transmission rate for the transmission data.

This configuration prevents reduction in the transmission rate for the transmission data containing the image data captured by the wireless camera.

In the above wireless camera system, the camera controller may limit an amount of the transmission data of the wireless camera, as the process for preventing reduction in the transmission rate for the transmission data, when the wireless camera is not selected by the camera selector.

With this configuration, the amount of the transmission data is limited for the wireless camera having not been selected by the central device. This enables the wireless camera having been selected to secure an available bandwidth to be used for radio transmission. As a result, the transmission data of the wireless camera having been selected is transmitted to the central device at a high transmission rate.

The above wireless camera system may further include: a band estimator configured to estimate an available bandwidth to be used by the camera-side radio communicator for radio communication of the transmission data; and a band predictor configured to predict an available bandwidth for the wireless camera, based on an estimated value of the available bandwidth by the band estimator, wherein the camera controller controls the wireless camera to issue a warning, as the process for preventing reduction in the transmission rate for the transmission data, when the band predictor predicts that the available bandwidth for the wireless camera is likely to decrease in a case where the wireless camera is selected by the camera selector.

This configuration enables a user of the selected wireless camera to know that the available bandwidth for the wireless camera is predicted to decrease, although the wireless camera has been selected. The user, then, can take action such as changing his/her position so as to secure the available bandwidth.

The above wireless camera system may further include: a band estimator configured to estimate an available bandwidth to be used by the camera-side radio communicator for radio communication of the transmission data; and a band predictor configured to predict an available bandwidth for the wireless camera, based on an estimated value of the available bandwidth by the band estimator, wherein the display is configured to display a result of prediction obtained by the band predictor, as the process for preventing reduction in the transmission rate for the transmission data.

This configuration enables a user of the central device to easily perceive the result of prediction of the available bandwidth for each of the wireless cameras.

In the above wireless camera system, each of the plurality of wireless cameras is set a priority by a user of a central device, and the controllers of the plurality of wireless cameras which have not been selected via the camera selector by the user of the central device limit the amounts of the transmission data of the unselected wireless cameras according to the priority of the wireless cameras.

With this configuration, when a plurality of wireless cameras are not selected, the amounts of the transmission data are limited, depending on the priority of each of the wireless cameras.

In the above wireless camera system, when the wireless camera is not selected by the camera selector, the camera controller limits the amount of the transmission data of the unselected wireless camera, when another wireless camera selected by the camera selector has a higher priority than the unselected wireless camera, and the camera controller does not limit the amount of the transmission data of the unselected wireless camera, when another wireless camera selected by the camera selector has a higher priority than the unselected wireless camera.

This configuration enables even a wireless camera having not been selected to secure the amount of transmission data, when the wireless camera has a high priority.

In the above wireless camera system, the camera controller limits the amount of the transmission data by changing a resolution of the image data.

This configuration enables the wireless camera having been selected to effectively secure the available bandwidth for radio transmission of transmission data, by lowering the resolution of an image taken by the wireless camera having not been selected.

In the above wireless camera system, the camera controller limits the amount of the transmission data by changing a frame rate of the image data.

This configuration enables the wireless camera having been selected to effectively secure the available bandwidth for radio transmission of transmission data, by lowering the frame rate of an image taken by the wireless camera having not been selected.

In the above wireless camera system, the camera controller limits the amount of the transmission data by transmitting a still image only as the transmission data.

This configuration enables the wireless camera having been selected to effectively secure the available bandwidth for radio transmission of transmission data, by transmitting an image taken by the wireless camera which has not been selected as a still image.

In the above wireless camera system, the camera controller limits the amount of the transmission data by transmitting metadata of the image data only as the transmission data.

This configuration enables the wireless camera which has been selected to effectively secure the available bandwidth for radio transmission of transmission data, by transmitting metadata only from the wireless camera which has not been selected.

The above wireless camera system may further include: a band estimator configured to estimate an available bandwidth to be used by the camera-side radio communicator for radio communication of the transmission data; and a band predictor configured to predict an available bandwidth for the wireless camera, based on an estimated value of the available bandwidth by the band estimator, wherein the camera controller controls the wireless camera to issue a warning, as the process for preventing reduction in the transmission rate for the transmission data, when the band predictor predicts that the available bandwidth for the wireless camera is likely to decrease in a case where the wireless camera is selected by the camera selector.

This configuration enables a user of the selected wireless camera to know that the available bandwidth for the wireless camera is predicted to decrease, although the wireless camera has been selected by a user of the central device. The user of the wireless camera, then, can take action such as changing his/her position so as to secure the available bandwidth.

The above wireless camera system may further include: a band estimator configured to estimate an available bandwidth to be used by the camera-side radio communicator for radio communication of the transmission data; and a band predictor configured to predict an available bandwidth for the wireless camera, based on an estimated value of the available bandwidth by the band estimator, wherein the display displays a result of prediction obtained by the band predictor of the wireless camera, as the process for preventing reduction in the transmission rate for the transmission data, the result of prediction being associated with image data from the wireless camera.

This configuration enables a user of the central device to easily perceive the result of prediction of the available bandwidth for each of the wireless cameras.

In the above wireless camera system, wherein the display is configured to display a display screen on which image data from the wireless camera selected by the camera selector is superimposed on a map image indicating locations of the plurality of wireless cameras.

This configuration makes it possible to check both the location of the wireless camera and image data from the same wireless camera simultaneously.

In the above wireless camera system, the display is configured to display a display screen on which a sign appears at a location of the wireless camera on the map image so as to indicate that the wireless camera is present.

This configuration makes it possible to check the location of the wireless camera by means of the sign on the map image.

In the above wireless camera system, the display is configured to display image data of the wireless camera at the location of the wireless camera on the map image.

This configuration makes it possible to check both the location of the wireless camera and image data from the same wireless camera simultaneously.

In the above wireless camera system, the display is configured to display image data of the wireless camera, the image data being associated with the wireless camera in the map image.

This configuration makes it possible to easily check which wireless camera located in which position has captured the displayed image data.

A central device according to one aspect performs a process for preventing reduction in a transmission rate for transmission data containing image data from each of the wireless cameras.

This configuration makes it possible to prevent reduction in the transmission rate for transmission data containing image data captured by the wireless camera.

The above central device may further includes: a band predictor configured to predict an available bandwidth for each of the wireless cameras, based on an estimated value of the available bandwidth to be used for transmission of transmission data containing image data from each of the wireless cameras wirelessly; a camera selector for a user of the central device to select a part of wireless cameras from the plurality of wireless cameras; and a central device-side radio communicator configured to transmit a control command to the wireless camera to cause the wireless camera to issue a warning, as the process for preventing reduction in the transmission rate for the transmission data, when the band predictor predicts that the available bandwidth for the wireless camera having been selected by the camera selector is likely to decrease.

This configuration enables a user of the wireless camera having been selected by the user of the central device to know that the available bandwidth for the wireless camera is predicted to decrease, although the wireless camera has been selected. The user of the wireless camera, then, can take action such as changing his/her position so as to secure the available bandwidth.

The above central device may further includes a controller configured to display a result of prediction of an available bandwidth to be used for transmission of transmission data containing image data from the wireless camera by means of radio communication, as the process for preventing reduction in the transmission rate for the transmission data, the result of prediction being associated with image data from the wireless camera.

This configuration enables the user of the central device to easily perceive the result of prediction of the available bandwidth for each of the wireless cameras.

The above central device may further includes a band predictor configured to predict the available bandwidth for each of the wireless cameras, based on an estimated value of the available bandwidth to be used for transmission of transmission data containing image data from each of the wireless cameras wirelessly.

This configuration enables the user of the central device to easily perceive the result of prediction of the available bandwidth for each of the wireless cameras.

An image display method according to one aspect includes: a capturing step configured to captures an image to generate image data by each of a plurality of wireless cameras; a transmission step configured to transmit transmission data containing the image data wirelessly from the wireless cameras; a camera selection step configured to select a part of wireless cameras among the plurality of wireless cameras; a display step configured to display the image data contained in the transmission data, depending on a selection made in the camera selection step; and a processing step configured to prevent reduction in a transmission rate for the transmission data.

This configuration prevents reduction in the transmission rate for the transmission data containing the image data captured by the wireless camera.

In the above image display method, the processing process is configured to limits an amount of the transmission data of the wireless camera which is not selected in the camera selection step, as the process for preventing reduction in the transmission rate for the transmission data.

With this configuration, the amount of the transmission data is limited for the wireless camera having not been selected by the central device. This enables the wireless camera having been selected to secure an available bandwidth to be used for radio transmission of the transmission data. As a result, the transmission data is transmitted to the central device at a high transmission rate.

The image display method according to another aspect further include: a band estimation step configured to estimate an available bandwidth for radio communication of the transmission data by the transmission step; and a band prediction step configured to predict an available bandwidth for the wireless camera, based on an estimated value of the available bandwidth by the band estimation step, wherein the processing process is configured to control the wireless camera to issue a warning when the available bandwidth for the wireless camera which is not selected in the camera selection step is predicted to be likely to decrease in the band prediction step, as the process for preventing reduction in the transmission rate for the transmission data.

This configuration enables a user of the selected wireless camera to know that the available bandwidth for the wireless camera is predicted to decrease, although the wireless camera has been selected by a user of the central device. The user of the wireless camera, then, can take action such as changing his/her position so as to secure the available bandwidth.

The above image display method may further include: a band estimation step configured to estimate an available bandwidth for radio communication of the transmission data by the transmission step; and a band prediction step configured to predict an available bandwidth for the wireless camera, based on an estimated value of the available bandwidth by the band estimation step, wherein the processing process is configured display a result of prediction obtained by the band prediction step, as the process for preventing reduction in the transmission rate for the transmission data, the result of prediction being associated with image data from the wireless camera.

This configuration enables a user of the central device to easily perceive the result of prediction of the available bandwidth for each of the wireless cameras.

An image display program according to one aspect is configured to cause a computer of a central device forming, together with a plurality of wireless cameras, a wireless camera system, to function as a computer which performs a process for preventing reduction in a transmission rate for transmission data containing image data from each of the wireless cameras.

This configuration enables a user of a selected wireless camera to know that the available bandwidth for the wireless camera is predicted to decrease, although the wireless camera has been selected. The user, then, can take action such as changing his/her position so as to secure the available bandwidth.

The above image display program to cause the computer to function further as: a band predictor configured to predict an available bandwidth for each of the wireless cameras, based on an estimated value of the available bandwidth to be used for transmission of transmission data containing image data from each of the wireless cameras by means of radio communication; and a controller configured to display a result of prediction obtained by the band predictor, as the process for preventing reduction in the transmission rate for the transmission data, the result of prediction being associated with image data from the wireless camera.

This configuration enables a user of the central device to easily perceive the result of prediction of the available bandwidth for each of the wireless cameras.

The above image display program to cause the computer to function further as a controller configured to display a result of prediction of an available bandwidth to be used for transmission of the transmission data by the wireless camera wirelessly, as the process for preventing reduction in the transmission rate for the transmission data, the result of prediction being associated with image data from the wireless camera.

This configuration enables a user of the central device to easily perceive the result of prediction of the available bandwidth for each of the wireless cameras.

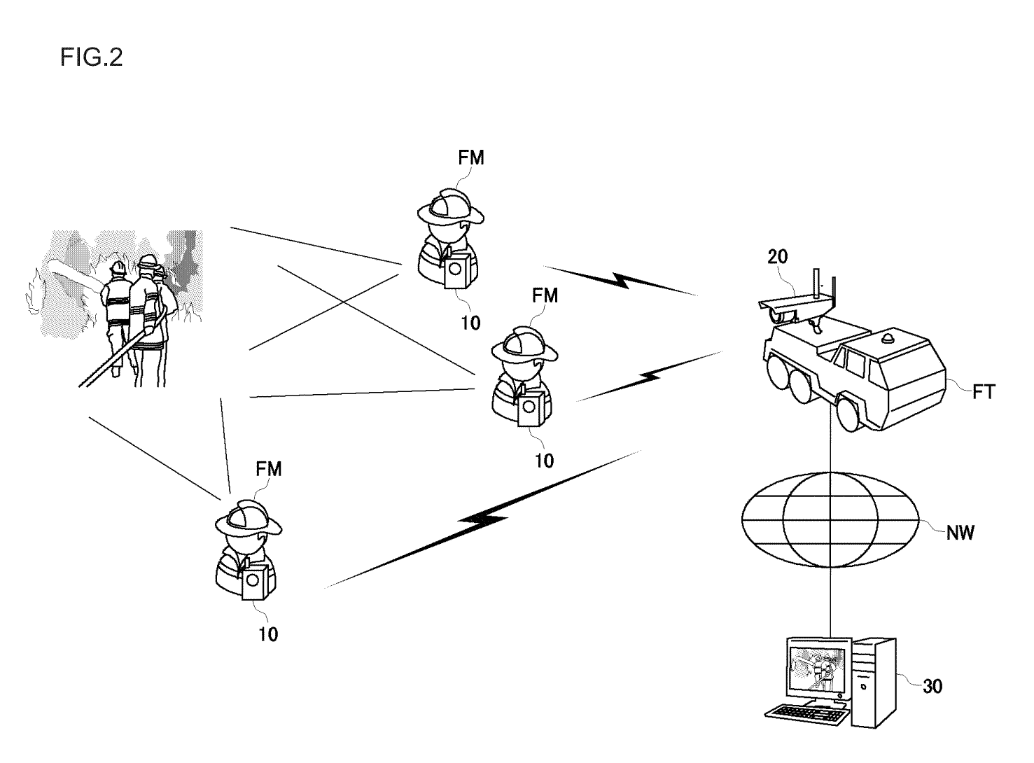

The wireless camera system of an embodiment is described below, with reference to the drawings. FIG. 2 is a diagram showing an entire configuration of the wireless camera system of the embodiment. The wireless camera system 100 includes a plurality of wireless cameras 10, an access point 20, and a central device (a viewer) 30. The wireless camera system is applicable to a system for checking a scene of a fire, a system for pursuing a criminal, and the like. FIG. 2 shows an example of the wireless camera system 100 used as a system for checking a scene of a fire. In this example, the wireless camera 10 is a wearable camera worn by a fireman FM. The access point 20 is provided on a fire truck FT dispatched to the scene of the fire.

The wireless camera 10 and the access point 20 communicate wirelessly with each other using Wi-Fi (registered trademark). The central device 30 is placed in the headquarters distant from the scene of the fire. The access point 20 and the central device 30 communicate with each other via a public communication network NW including the Internet. The wireless camera 10 and the access point 20 can also communicate wirelessly with each other using a public wireless network.

In the wireless camera system 100, a plurality of wireless cameras 10 communicate with the central device 30 via the same access point 20. This means, when a plurality of wireless cameras 10 communicate with the access point 20 simultaneously, the wireless cameras 10 share a radio band with each other.

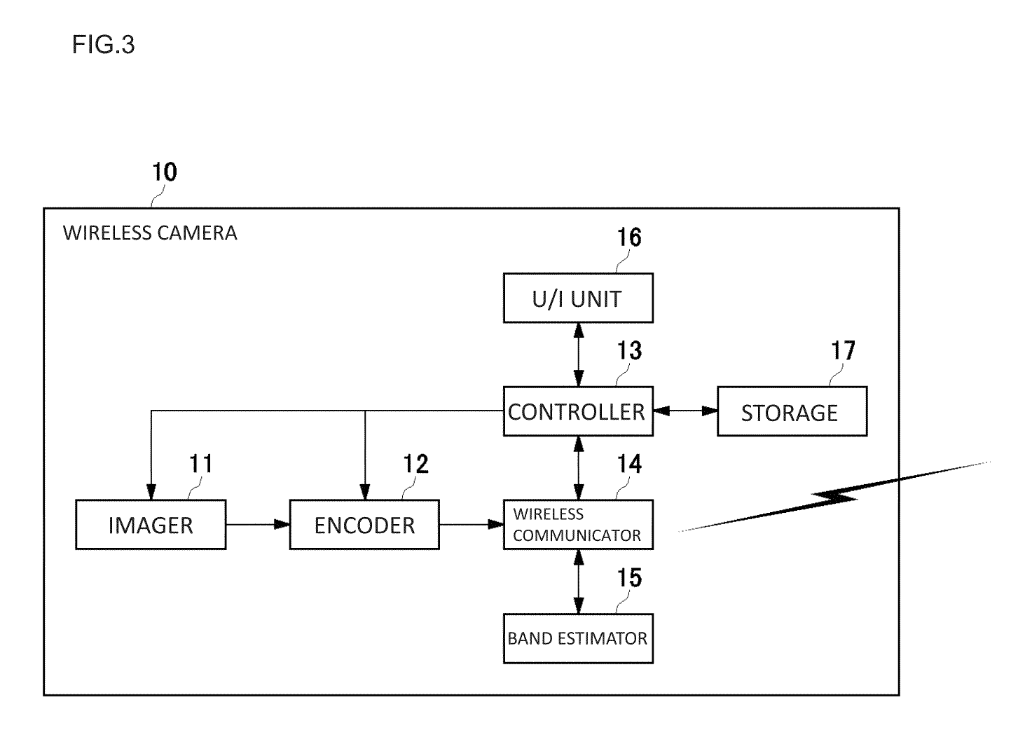

FIG. 3 is a block diagram showing a configuration of the wireless camera. The wireless camera 10 includes an imager 11, an encoder 12, a controller 13, a radio communicator 14, a band estimator 15, a user interface (U/I) unit 16, and storage 17. The imager 11 includes an imaging optical system, an imaging element, and a signal processing circuit and so on. The imager 11 converts an optical image of an imaging subject having passed through the imaging optical system into signals. The imaging optical system of the imager 11 is movable. The wireless camera 10 calculates a distance to an imaging subject in focus, based on the position of the imaging optical system. The encoder 12 generates image data by encoding signals obtained by image capturing by the imager 11. Specifically, the encoder 12 generates a moving-image data by using signals which are continuously input from the imager 11. The imager 11 and the encoder 12 form an image generator.

The controller 13 controls operations of the imager 11, the encoder 12, the radio communicator 14, the U/I unit 16, and the storage 17 of the wireless camera 10. The controller 13 controls the above components by following instructions from the U/I unit 16, and a control command (to be described) received by the radio communicator 14. In the present embodiment, the controller 13 controls the wireless camera 10, in accordance with the control command, to transform an image data transmitted from the radio communicator 14 from a moving-image data into a still-image data, or to issue a warning. The control command may be a command for changing the resolution in the imager 11, the frame rate in the encoder 12, and the parameter of image data contained in transmission data in the radio communicator 14.

The radio communicator 14 radio-communicates with the access point 20 using Wi-Fi (registered trademark), and communicates with the central device 30 via the access point 20. Specifically, the radio communicator 14 transmits transmission data containing image data encoded by the encoder 12 to the central device 30, and receives a control command from the central device 30. The transmission data transmitted by the radio communicator 14 contains, in addition to the image data, metadata including positional information (latitude and longitude) of the wireless camera 10, ID of the wireless camera 10, and other information such as the time of image capturing.

The band estimator 15 estimates an available bandwidth at the time of transmission of the transmission data. Specifically, the band estimator 15 transmits an estimation packet, with the transmission rate increasing (i.e., with the interval between estimation packets decreasing). The band estimator 15 then estimates the available bandwidth, based on at which transmission rate (i.e., at which interval) packet losses occur. The band estimator 15 outputs an estimate to the radio communicator 14. The radio communicator 14 transmits the estimate to the central device 30.

The U/I unit 16 is formed of a touch panel. The U/I unit 16 provides information to a user by image and sound, as well as receiving/accepting an operation input from the user. In addition, the U/I unit 16 gives a warning to the user, under the control based on the control command from the controller 13. The storage 17 stores image data and other data encoded by the encoder 12, under the control of the controller 13. The controller 13 also provides control to read the image data stored in the storage 17.

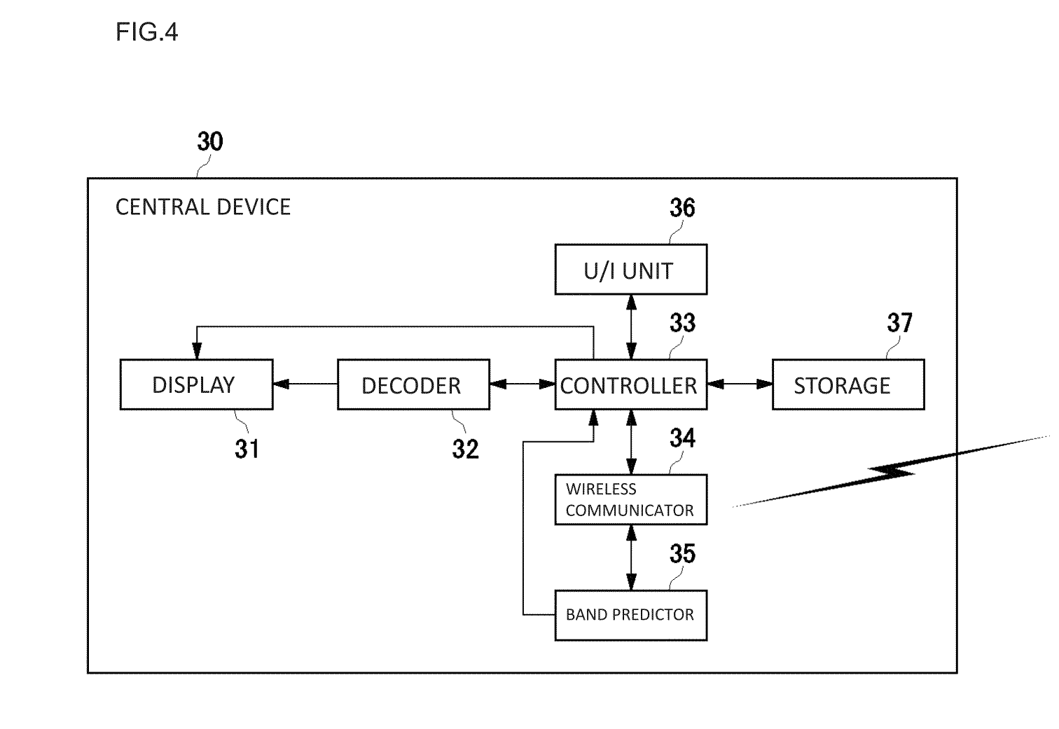

FIG. 4 is a block diagram showing a configuration of the central device. The central device 30 includes a display 31, a decoder 32, a controller 33, a radio communicator 34, a band predictor 35, a U/I unit 36, and storage 37. The radio communicator 34 communicates with the access point 20, and with each of the wireless cameras 10 via the access point 20. Specifically, the radio communicator 34 receives transmission data having been transmitted from each of a plurality of wireless cameras 10, and an estimate obtained as a result of a band estimation. The radio communicator 34 then transmits a control command to the wireless camera 10.

The controller 33 controls operations of the display 31, the decoder 32, the radio communicator 34, the U/I unit 36, and the storage 37 of the central device 30. The controller 33 which controls the display 31 functions as a display controller. The controller 33 controls the above components by following instructions from the U/I unit 36, transmission data received by the radio communicator 34, and a result of prediction obtained by the band predictor 35. The decoder 32 decodes the image data included in the transmission data having been received by the radio communicator 34.

The band predictor 35 predicts a bandwidth available in the future for each of the wireless cameras 10, based on the estimate of the available bandwidth for each of the wireless cameras 10, which has been received by the radio communicator 34. Specifically, the band predictor 35 determines whether the available bandwidth is likely to increase (the available bandwidth is likely to widen) or to decrease (to narrow), based on the change, from past to present, of the estimate of the available bandwidth for each of the wireless cameras 10. The band predictor 35 then outputs the result of determination as a result of prediction. In this prediction, an arbitrary prediction-algorithm can be used. For example, the band predictor 35 calculates moving averages of a plurality of estimates obtained at predetermined intervals before a certain time, and linear-approximates the moving averages. The band predictor 35 may determine that the available bandwidth is increasing, when an approximated straight line has a positive gradient, and determine that the available bandwidth is decreasing, when an approximated straight line has a negative gradient.

The display 31 displays the image data decoded by the decoder 32, the metadata contained in the transmission data received by the radio communicator 34, and the result of prediction obtained by the band predictor 35. A display screen which is shown on the display 31 will be described later. The U/I unit 36 accepts an operation input from a user. The U/I unit 36 may be integrated with the display 31 to form a touch panel. The U/I unit 36, specifically, accepts the selection of the wireless camera 10 by a user. In such case, the U/I unit 36 functions as a “camera selector”. The storage 37 stores transmission data received by the radio communicator 34, and a result of prediction obtained by the band predictor 35.

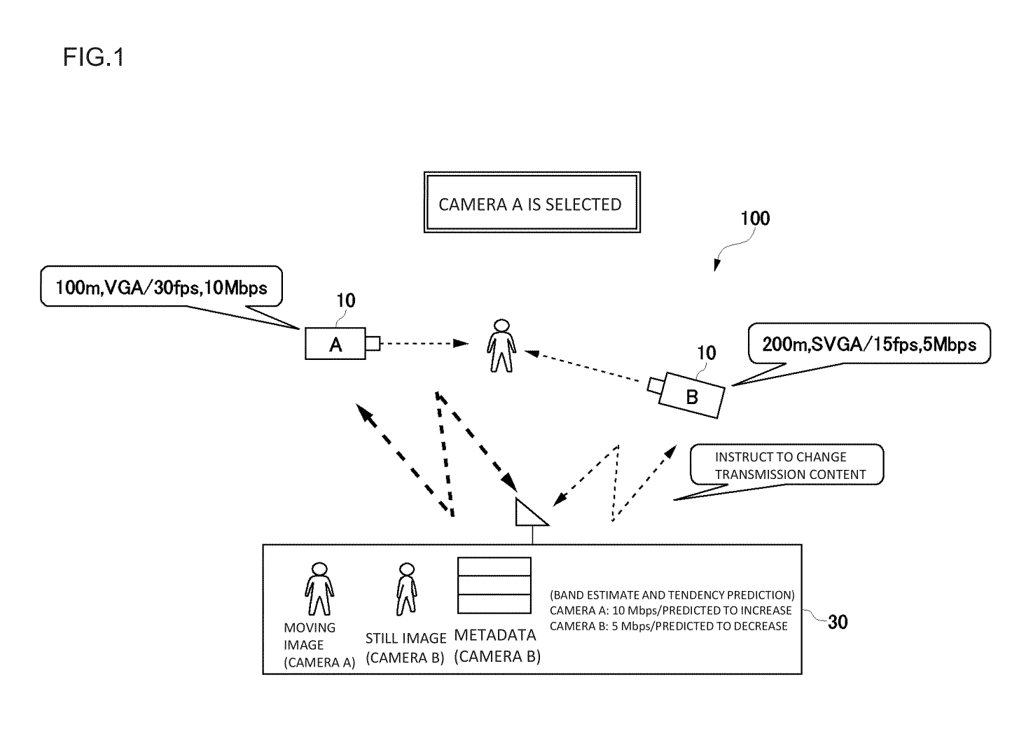

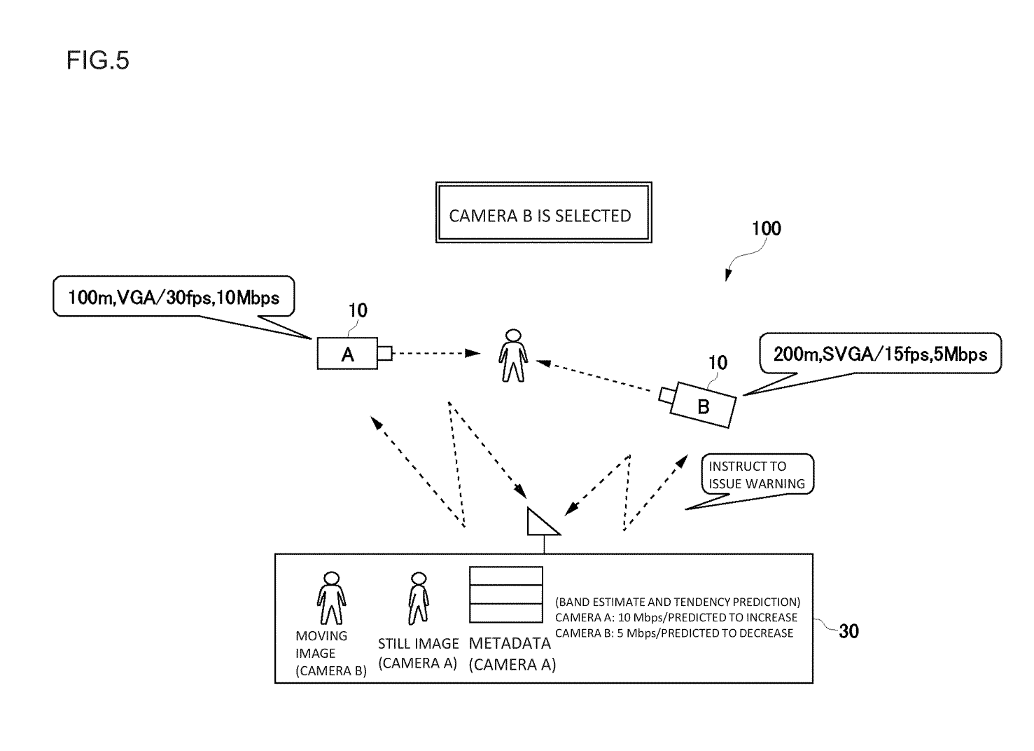

The following is a description of operations of the wireless camera system 100. FIGS. 1 and 5 are diagrams each showing an example of operations of the wireless camera system 100. In the example of FIG. 1, the wireless camera system 100 is provided with two (2) wireless cameras 10. The two (2) wireless cameras 10 are hereinafter referred to as a camera A and a camera B. The access point 20 is not shown in FIG. 1.

The cameras A and B transmit the image data obtained as a result of image capturing by the imager 11 and encoding by the encoder 12 to the central device 30, together with metadata, as transmission data. The cameras A and B also transmit, to the central device 30, an estimate of the available bandwidth calculated by the band estimator 15. The central device 30 receives transmission data and the estimate of the available bandwidth which are transmitted from each of the cameras A and B. The central device 30 then displays the received transmission data and the estimate on the display 31. The display 31 of the central device 30 also displays a result of prediction of a tendency of the available bandwidth for each of the cameras A and B predicted by the band predictor 35.

In the example of FIG. 1, the camera A is located at a distance of 100 m from the imaging subject. The camera A has a resolution of video graphics array (VGA: 640-by-480 pixels), a frame rate of 30 frames per second (fps), and an estimated available bandwidth of 10 megabytes per second (Mbps). The camera B is located at a distance of 200 m from the imaging subject. The camera B has a resolution of super video graphics array (SVGA: 800-by-600 pixels), a frame rate of 15 frames per second (fps). An estimated available bandwidth for the camera B to transmit transmission data is 5 megabytes per second (Mbps). The available bandwidth for the camera A is predicted to increase, while the available bandwidth for the camera B is predicted to decrease.

A user selects the camera A or B by inputting instructions to the U/I unit 36. FIGS. 1 and 5 show cases in which the cameras A and B, respectively, are selected. The central device 30 transmits a control command to the wireless camera 10, depending on the selection of the wireless camera 10.

In the example in FIG. 1, the available bandwidth for the camera A selected by the user is predicted to increase. The central device 30, therefore, transmits a control command to the unselected camera B to limit the amount of the transmission data from the camera B. The control command to limit the amount of the transmission data is, specifically, a control command to instruct to change transmission content. To be more specific, while moving-image data is normally transmitted from the wireless camera 10 to the central device 30, the wireless camera 10 transmits still-image data and metadata instead of the moving-image data, when the wireless camera 10 receives a control command to instruct to change transmission content. In such case, the still image data is updated at predetermined intervals (e.g., at intervals of three (3) seconds).

Consequently, as shown in FIG. 1, the selected camera A transmits moving-image data, while the unselected camera B transmits still-image data. Accordingly, the display 31 of the central device 30 displays a moving image as the image from the camera A, and a still image as the image from the camera B. In addition, metadata from the unselected camera B is also displayed.

As described above, when the available bandwidth for the selected wireless camera 10 is predicted to increase, the central device 30 displays a moving image, by causing the selected wireless camera 10 to transmit moving-image data composed of a relatively large amount of data, while the central device 30 displays a still image as well as metadata, by causing the unselected wireless camera 10 to transmit still-image data composed of a relatively small amount of data, which reduces the amount of transmission data from the unselected wireless camera 10. Accordingly, a bandwidth for transmission of moving-image data from the selected wireless camera 10 is secured sufficiently, and, at the same time, information and metadata about an image from the unselected wireless camera 10 are obtained.

FIG. 5 shows a case in which the camera B has been selected by the user under the same conditions as FIG. 1. In the example in FIG. 5, since the available bandwidth for the camera B selected by the user is predicted to decrease, the central device 30 transmits, to the selected camera B, a control command instructing to give a warning to the user. The selected camera B, when receiving the control command instructing to issue a warning, gives a warning to the user by using an alarm, a sound, a lamp, and the like. This enables the user, when receiving the warning, to know that the result of prediction of a tendency of the available bandwidth for the wireless camera 10 is not good, although the wireless camera 10 has been selected. The user, then, can take action such as moving to a good signal location.

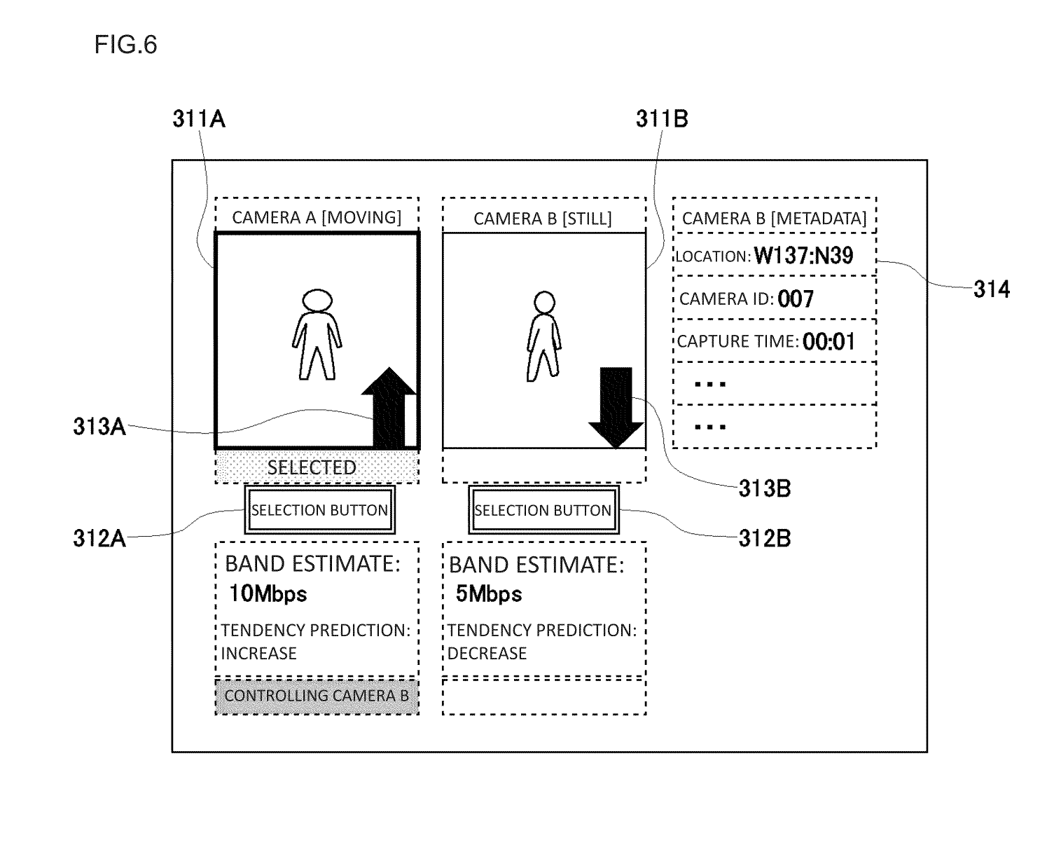

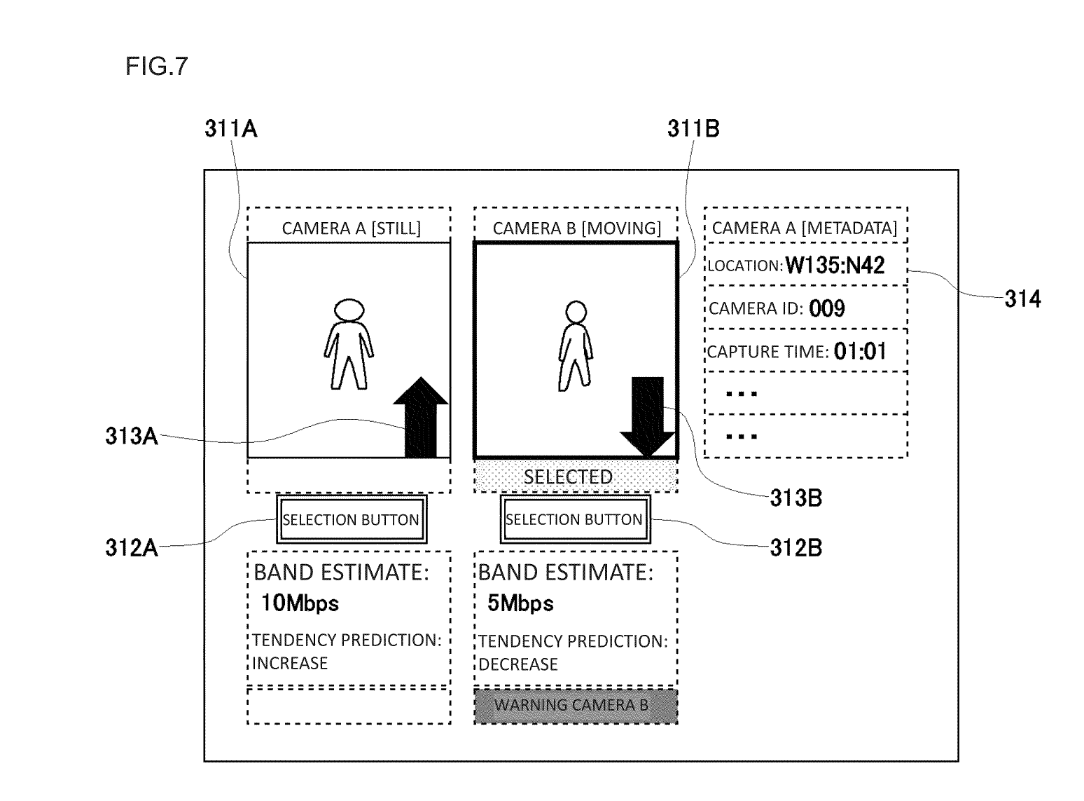

FIGS. 6 and 7 are diagrams showing examples of display screens shown by the display of the central device in the example cases in FIGS. 1 and 5, respectively. As the display screen also serves as the U/I unit 36, the user performs operation according to the display screen, so as to input data to the central device 30. In the example in FIG. 6, the display 31 corresponds to a monitor, the U/I unit 36 corresponds to a mouse. The user moves a pointer on the display 31 by using the mouse, and clicks the mouse, to input data to the central device 30.

As shown in FIGS. 6 and 7, the display screen contains images 311A and 311B transmitted from the cameras A and B, respectively. The images are displayed on the display 31, by decoding, in the decoder 32, image data contained in transmission data transmitted from each of the cameras A and B. Furthermore, there are provided selection buttons 312A and 312B, corresponding to the images 311A and 311B from each of the wireless cameras respectively, for selecting the cameras A and B, respectively.

In addition, corresponding to the images 311A and 311B of the wireless cameras, an estimate of the available bandwidth, and a result of prediction of the tendency (“increase” or “decrease”) of the available bandwidth are shown. The result of prediction of the tendency of the available bandwidth is also shown by a sign (an arrow) 313A, 313B. The signs 313A and 313B are displayed, being associated with the corresponding images 311A and 311B, respectively. In the examples in FIGS. 6 and 7, the signs 313A and 313B superimpose on the corresponding images 311A and 311B, respectively. The up-arrow 313A and down-arrow 313B indicate that the available bandwidth is likely to increase and decrease, respectively. This makes it possible, with a geometric shape, to visually perceive the result of prediction of the tendency of the available bandwidth.

FIG. 6 shows the display screen at the time when the camera A has been selected. When the selection button 312A is indicated, the camera A is selected. The available bandwidth for the selected camera A is predicted to increase by the band predictor 35. The controller 33, therefore, when informed from the U/I unit 36 that the camera A has been selected, transmits to the unselected camera B, through the radio communicator 34, a control command to limit the amount of the transmission data. At the same time, the controller 33 provides control to display a sign “selected” below the image 311A, which indicates that the image from the camera A has been selected. Also at this time, the image 311A is surrounded with a thick frame. In addition, a sign indicating that the unselected camera B is currently controlled by a control command appears on the display screen.

Also in the example in FIG. 6, a moving image (a video) is displayed for the selected camera A, while a still image is displayed for the unselected camera B. For the unselected camera B, metadata 314 thereof is displayed as well.

FIG. 7 shows the display screen at the time when camera B has been selected. When the selection button 312B is indicated, the camera B is selected. The available bandwidth for the selected camera B is predicted to decrease by the band predictor 35. The controller 33, therefore, when informed from the U/I unit 36 that camera B has been selected, transmits to the selected camera B, through the radio communicator 34, a control command to issue a warning. At the same time, the controller 33 provides control to display a sign “selected” below the image 311B, which indicates that the image from the camera B has been selected. Also at this time, the image 311B is surrounded with a thick frame. In addition, a sign indicating that the selected camera B has warning appears on the display screen.

Also in the example in FIG. 7, a moving image (a video) is displayed for the selected camera B, while a still image is displayed for the unselected camera A. For the unselected camera A, metadata 314 thereof is displayed as well.

The controller 33 controls the display 31 to generate the display screens of FIGS. 6 and 7. The controller 33 generates the display screen, based on transmission data and an estimate of an available bandwidth which are received by the radio communicator 34, a result of prediction obtained by the band predictor 35, and the selection of the wireless camera 10 input from the U/I unit 36.

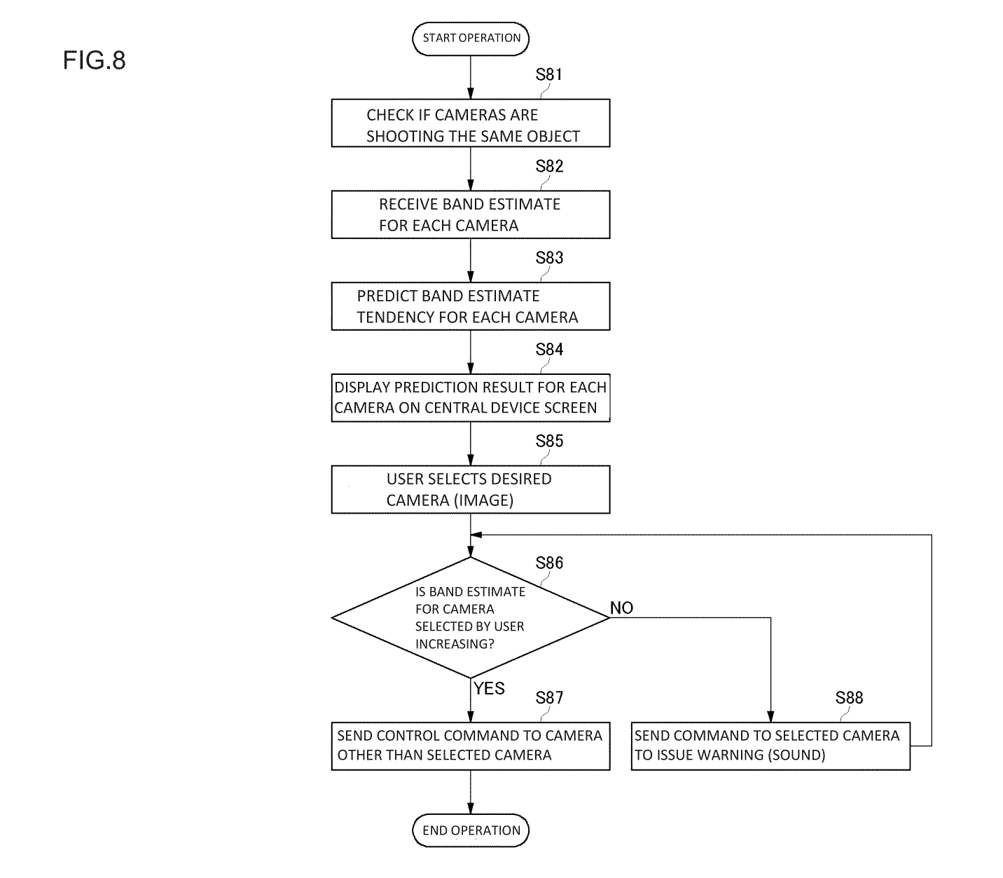

The following is a description of operations of the central device 30. FIG. 8 is a flow diagram showing a flow of operations of the central device 30. First, a user of the central device 30 (a person in the headquarters) checks that a plurality of wireless cameras 10 are capturing the same object (step S81). Next, the band estimator 15 of each of the wireless cameras 10 estimates an available bandwidth, and the central device 30 receives an estimate of the available bandwidth for each of the wireless cameras 10 (step S82). The band predictor 35, based on the estimate, predicts the future tendency of the available bandwidth for each of the wireless cameras 10 (step S83). The controller 33 generates, for each of the wireless cameras 10, a screen for showing a result of prediction of the available bandwidth. The result of prediction is associated with an image from each of the wireless cameras 10. The controller 33 controls the display 31 to display the screen showing the result of prediction (step S84).

A user checks the screen containing an image from each of the wireless cameras 10, and a result of prediction of the available bandwidth for each of the wireless cameras 10. The result of prediction is associated with the image from each of the wireless cameras 10. The user then selects the image he/she wishes to watch (step S85). The controller 33, when informed from the U/I unit 36 of which image (or which wireless camera 10) has been selected, determines whether or not the available bandwidth for the selected wireless camera 10 is likely to increase (step S86). When the available bandwidth for the selected wireless camera 10 is likely to increase (YES in step S86), the controller 33 transmits a control command to the wireless cameras 10 other than the selected wireless camera, to limit the amount of transmission data (step S87). On the other hand, when the available bandwidth for the selected wireless camera 10 is not likely to increase (i.e., is likely to decrease, NO in step S86), the controller 33 transmits a control command to the selected wireless camera 10 to issue a warning (step S88).

As described above, a control command to reduce the amount of transmission data is transmitted to the unselected wireless camera 10. The controller 13 of the wireless camera 10 which has received the above control command reduces the amount of transmission data, following the control command, by switching from transmission of moving-image data to transmission of still-image data.

### (Variation 1)

In the foregoing embodiment, to simplify the explanation, a description has been given of a case in which two (2) wireless cameras 10 are provided. The above embodiment is applicable to a case in which three (3) or more wireless cameras 10 are provided. The following is a description of a variation of the embodiment with three (3) or more wireless cameras 10.

When there are three (3) or more wireless cameras 10, the wireless cameras 10 can be prioritized and controlled in accordance with their priority, in addition to controlling the wireless cameras 10 distinctively depending simply on whether they are selected or unselected. For example, there are four (4) wireless cameras 10 called cameras A, B, C, and D. The wireless cameras 10 are prioritized in order of the camera A, camera B, camera C, and camera D.

In this case, the central device 30 may transmit a control command to limit the amount of transmission data to only the wireless cameras 10 having lower priority than the selected wireless camera 10. Specifically: when the camera A is selected, the central device 30 may transmit a control command to limit the amount of transmission data to all of the cameras B, C, and D which have lower priority than the camera A; when the camera B is selected, the central device 30 may transmit a control command to limit the amount of transmission data to only the cameras C and D which have lower priority than the camera B; when the camera C is selected, the central device 30 may transmit a control command to limit the amount of transmission data to only the camera D which has lower priority than the camera C; and when the camera D is selected, the central device 30 may not transmit a control command to limit the amount of transmission data to any of the cameras A to C, as there is no wireless camera having lower priority than the camera D.

In another example, while the central device 30 transmits a control command to limit the amount of transmission data to all the unselected wireless cameras 10, as in the previous embodiment, the amounts of the transmission data may be limited according to the priority of the unselected wireless cameras 10. In other words, the controller 13 of the wireless camera 10, when receiving the control command to limit the amount of the transmission data, may reduce the amount of transmission data to the extent depending on the priority of the wireless camera 10.

### (Variation 2)

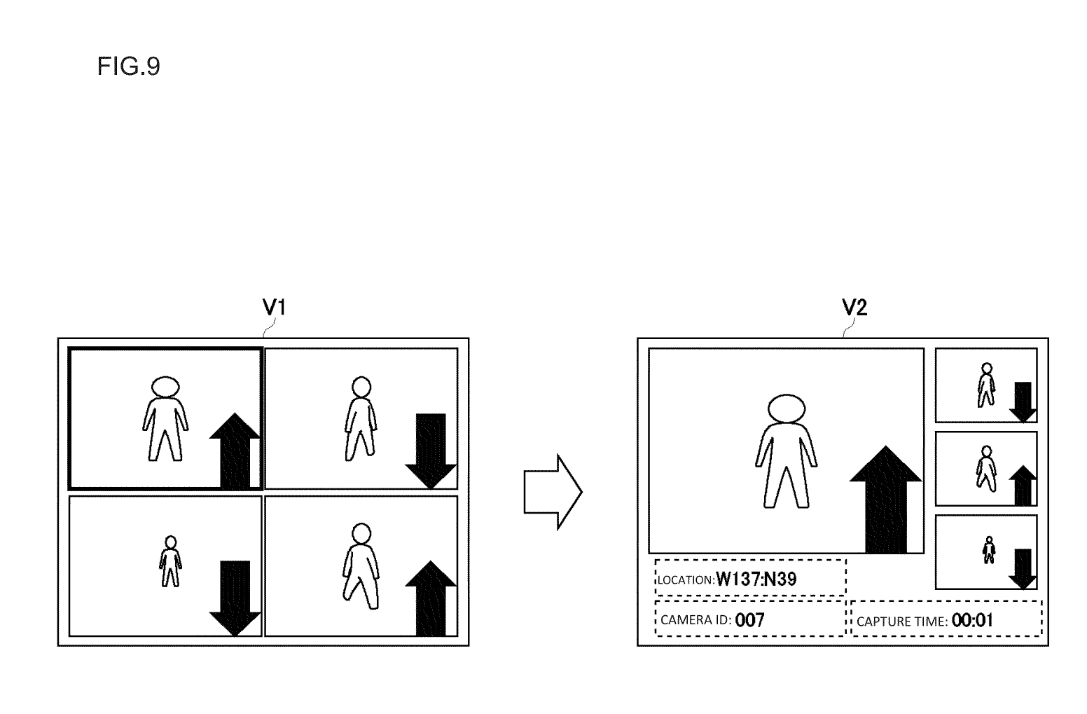

The following is a description of a variation of a method for displaying an image in the central device 30, with three (3) or more wireless cameras 10. FIG. 9 is a diagram showing an example of the display screen in the central device 30, with four (4) wireless cameras 10. A display screen V1 on the left side of FIG. 9 is a display screen which appears at the time of selecting one of the wireless cameras. A display screen V2 on the right side of FIG. 9 is a display screen which appears after one of the wireless cameras has been selected. In the example in FIG. 9, the upper left image in the display screen V1 has been selected.

In the display screen V1, the images from the four (4) wireless cameras 10 are displayed all in the same size. In each of the images, the tendency of the available bandwidth predicted by the band predictor 35 is indicated by an arrow. The user of the central device 30 selects one of the images, by clicking directly on the image he/she wishes to select, on the display screen V1. FIG. 9 shows that the upper left image has been selected and surrounded by a thick frame.

When the image is selected, the display screen switches to the display screen V2 as shown on the right side of FIG. 9. In the display screen V2, the selected image is displayed in a larger size. The display screen V2 also displays the metadata of the selected image. The unselected image is displayed in a smaller size. Also at this time, the tendency of the available bandwidth predicted by the band predictor 35 is indicated by an arrow, for all of the images. As described above, in this variation, the size of the image changes depending on the selection of the image (or the wireless camera 10). This enables the user to view the image he/she wishes to watch in a larger size, while observing the images from the other wireless cameras 10 as well. When one of the unselected images (small images) is selected on the display screen V2, the newly selected image is displayed in a large size, while the image which has originally been selected is displayed in a small size.

### (Variation 3)

In the example of FIG. 8, the controller 33 limits the amount of transmission data for the unselected wireless cameras 10, by transmitting a control command to limit the amount of transmission data to the unselected wireless cameras 10, only when the available bandwidth for the selected wireless camera 10 is likely to increase. In this variation, however, the controller 33 may also transmit a control command to limit the amount of transmission data to the unselected wireless cameras 10, when the available bandwidth for the selected wireless camera 10 is likely to decrease. In other words, the controller 33 may transmit a control command to limit the amount of transmission data to the unselected wireless cameras 10, regardless of whether the available bandwidth for the selected wireless camera 10 is likely to increase or decrease.

### (Variation 4)

In the embodiment described previously, to select the image from the wireless camera 10, the user inputs his/her selection through the U/I unit 36 in the central device 30. In this variation, the selection may be made automatically. In this case, the central device 30 has a camera selector which automatically selects the image from the wireless camera 10. For example, the camera selector selects, from among the images from a plurality of wireless cameras 10, the image of a moving object. Alternatively, the camera selector may select the image of a specified imaging subject.

The wireless camera system 100 described above is used, for example, as a surveillance camera system. Specifically, when a plurality of wireless cameras 10 are capturing images of an object under observation, but only one of the wireless cameras 10 is capturing the image of a suspicious person or a specified imaging subject (such as a criminal), the camera selector selects such wireless camera 10. The presence of a suspicious person is detected, for example, by finding a moving object when capturing images of an object under observation which is supposed to be immobile. The specified imaging subject is detected from the images by performing image processing such as pattern matching.

When a plurality of wireless cameras 10 are simultaneously capturing images of a suspicious person or a moving object, the camera selector selects the final wireless camera 10, based on a degree of motion, and matching scores. Alternatively, the camera selector can select a plurality of wireless cameras 10.

### (Variation 5)

In the embodiment described previously, the band predictor 35 is placed in the central device 30. In this variation, the band predictor 35 may be placed in each of the wireless cameras 10. In such case, the central device 30 transmits, to the wireless camera 10, signals indicating which wireless camera 10 has been selected. In the wireless camera 10, when selected, the controller 13 may control the wireless camera 10 by limiting the amount of transmission data or issuing a warning, based on the result of prediction obtained by the band predictor 35. Moreover, while the band estimator 15 is placed in the wireless camera 10 in the embodiment described previously, the band estimator 15, in addition to the band predictor 35, may be placed in the central device 30 in this variation.

### (Variation 6)

In the embodiment described previously, the controller 13 of the wireless camera 10, when receiving the control command to limit the amount of transmission data, controls the wireless camera 10 to transmit still-image data instead of the moving-image data, in order to reduce the amount of the transmission data. In this variation, the controller 13 may reduce the amount of transmission data, by: lowering the resolution of a captured image in the imager 11; lowering the frame rate in the encoder 12; and/or transmitting metadata only, without transmitting image data.

### (Variation 7)

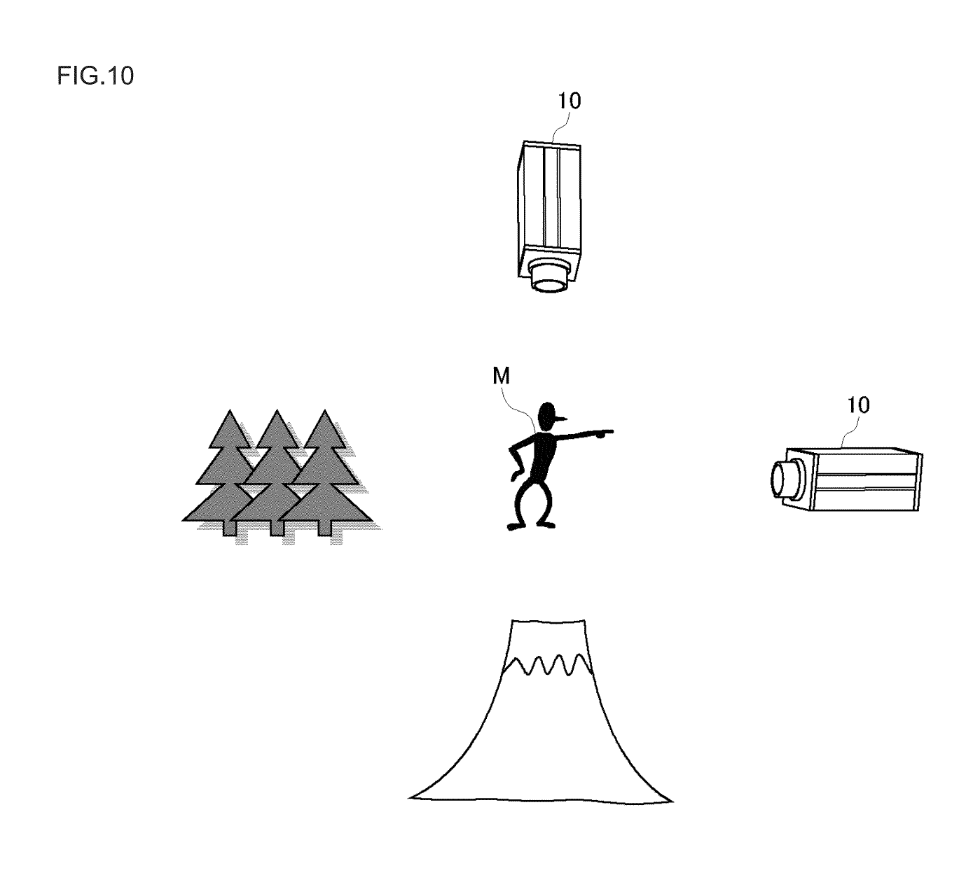

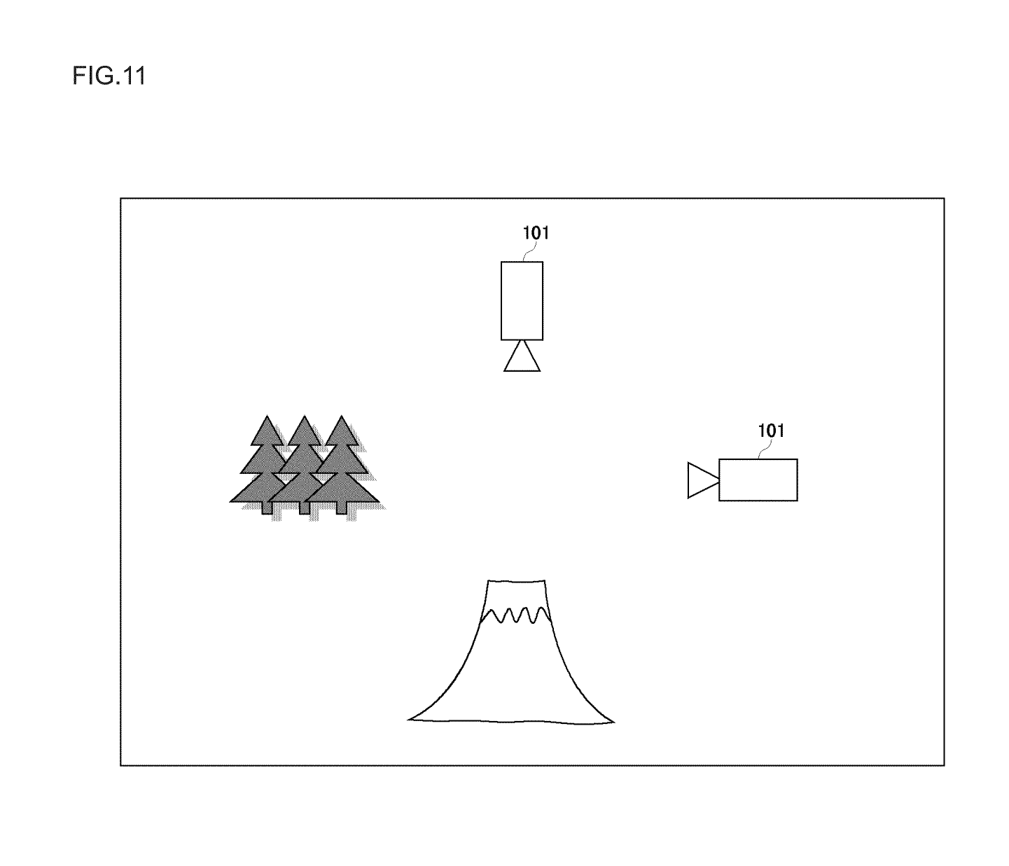

FIG. 10 is a diagram showing locations of a plurality of wireless cameras 10 in Variation 7. FIG. 10 shows the actual locations of two (2) wireless cameras 10. There is a person M in the field of view of the wireless cameras 10. FIG. 11 is a diagram showing an example of the display screen in the central device 30. The display screen of FIG. 11 is a display screen for displaying a video from the wireless camera 10 located as shown in FIG. 10. As shown in FIG. 11, the display screen displays a map of a space in which the wireless cameras 10 are located. In the position of each of the wireless cameras 10, an icon 101 representing the wireless camera 10 is superimposed on the map image. The icons 101 representing the wireless cameras 10 may have the same form, as shown in FIG. 11, for any of the wireless cameras 10, or may have different forms depending on the product number, performance specification, order of priority, and so on, of the wireless camera 10. When different wireless cameras 10 are represented by different icons, it is easier for a user to distinguish the wireless camera 10 from the other wireless cameras 10, when the user gives instructions to the wireless camera 10 via the U/I unit 36. Obviously, even if there actually is a person M as shown in FIG. 10, the person M does not appear on the display screen of FIG. 11, since the display screen of FIG. 11 displays a map image which has been prepared in advance.

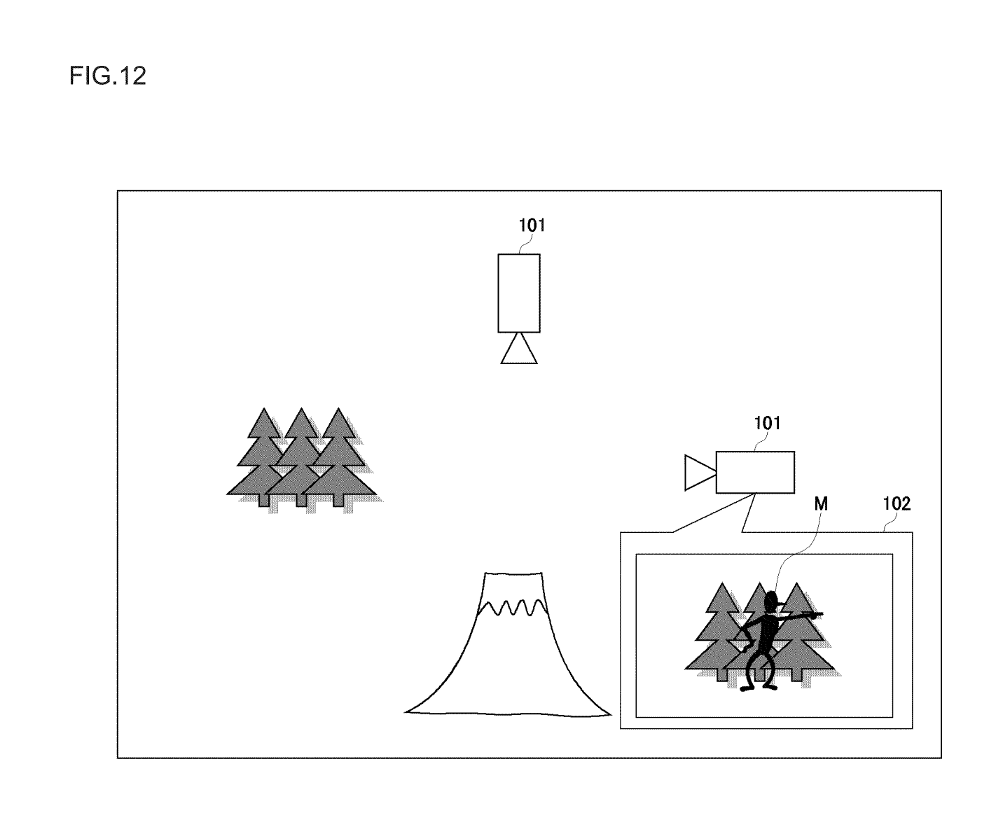

When a user gives instructions on any of the wireless camera icons 101 through the U/I unit 36 in the central device 30, a video 102 taken by the wireless camera 10 corresponding to the wireless camera icon 101 which has received the instructions is superimposed on the map image, as shown in FIG. 12. The video is linked with the wireless camera icon 101. In the example in FIG. 12, the video taken by the wireless camera 10 corresponding to the wireless camera icon 101 is superimposed on the map image, in the vicinity of the wireless camera icon 101. Since the video which has actually been taken by the wireless camera 10 is displayed, the person M appears on the video. The video 102 may be displayed, in such a manner that the video 102 is superimposed on the position of the corresponding wireless camera icon 101, or that the wireless camera icon 101 is replaced by the video 102.

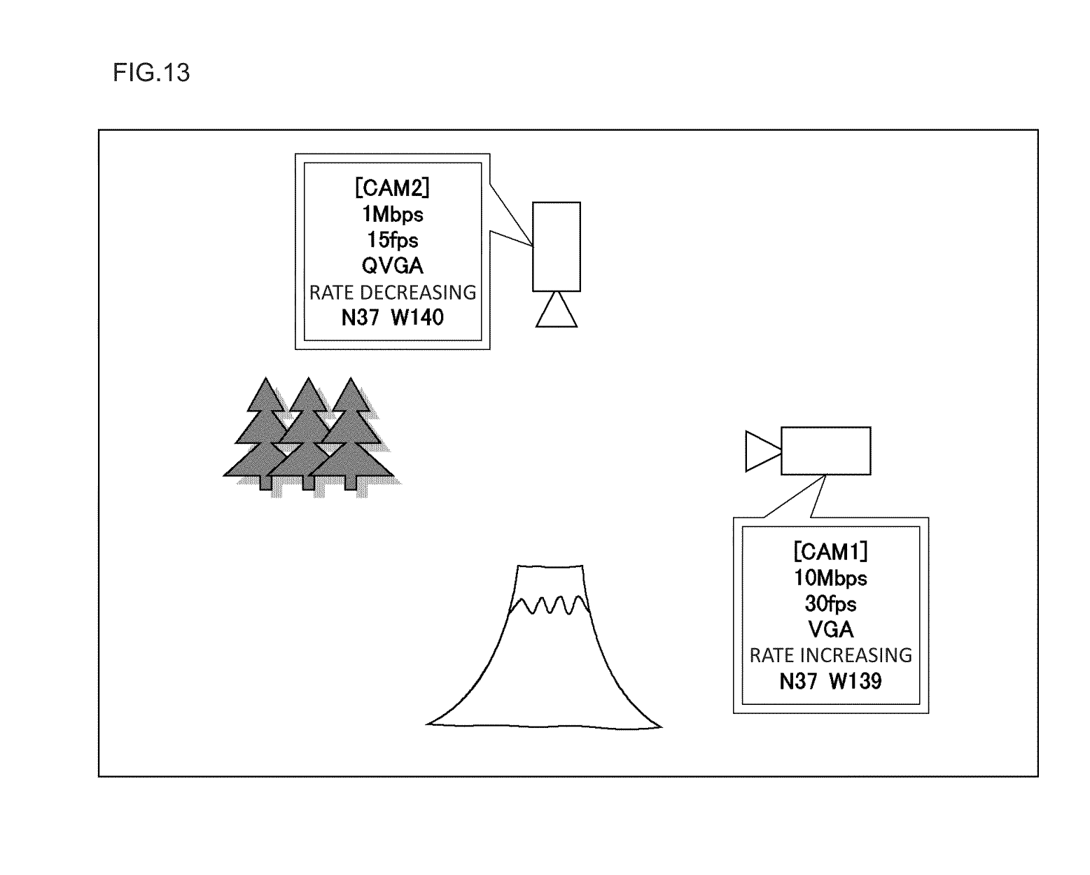

Furthermore, by giving the above instructions on the wireless camera icon 101, or by giving instructions, on the wireless camera icon 101, other than the instructions to display the video as described above, the metadata of the wireless camera 10 may be superimposed on the map image, being linked with the corresponding wireless camera icon 101, as shown in FIG. 13. Furthermore, as in the embodiment described previously, for the selected wireless camera 10, the video may be displayed, being linked with the corresponding wireless camera icon 101, and, for the unselected wireless camera 10, metadata may be displayed, being linked with the corresponding wireless camera icon 101. Alternatively, the display screen shown in FIGS. 6, 7, and 9 may be superimposed on the map image, in such a manner that the display screen is linked with the wireless camera icon 101, or that the display screen replaces the corresponding wireless camera icon 101.

The display screen described above makes it possible to clearly recognize which wireless camera 10 located in which position has taken the video currently displayed, and also to easily predict the video to be obtained when the currently unselected wireless camera 10 is selected.

### (Variation 8)

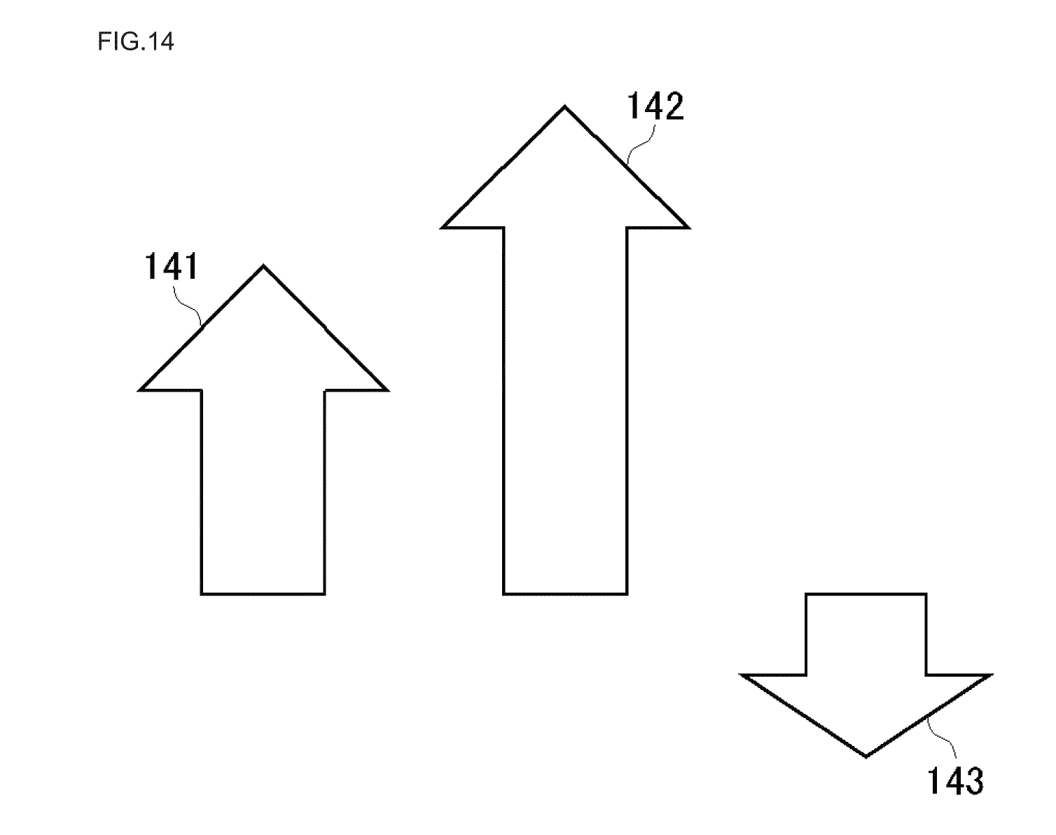

In the embodiment described previously, the result of prediction of the tendency of the available bandwidth is indicated by displaying an arrow superimposed on the video taken by the wireless camera 10. In this variation, the arrow may represent more information. FIG. 14 is a diagram showing an example of the arrow. In the example, the length of the arrow represents the strength of the tendency of the available bandwidth to increase and decrease (broaden and narrow). Specifically, in the example, not only the arrow indicates that the available bandwidth has a tendency to increase when the arrow is pointing up, or that the available bandwidth has a tendency to decrease when the arrow is pointing down, but also the length of the arrow represents the strength of the tendency of the available bandwidth to increase and decrease. In the example in FIG. 14: the arrow 141 represents that the available bandwidth has a tendency to increase, but the tendency is not very strong; the arrow 142 represents that the available bandwidth has a tendency to increase, and the tendency is relatively strong; and the arrow 143 represents that the available bandwidth has a tendency to decrease, but the tendency is relatively weak.

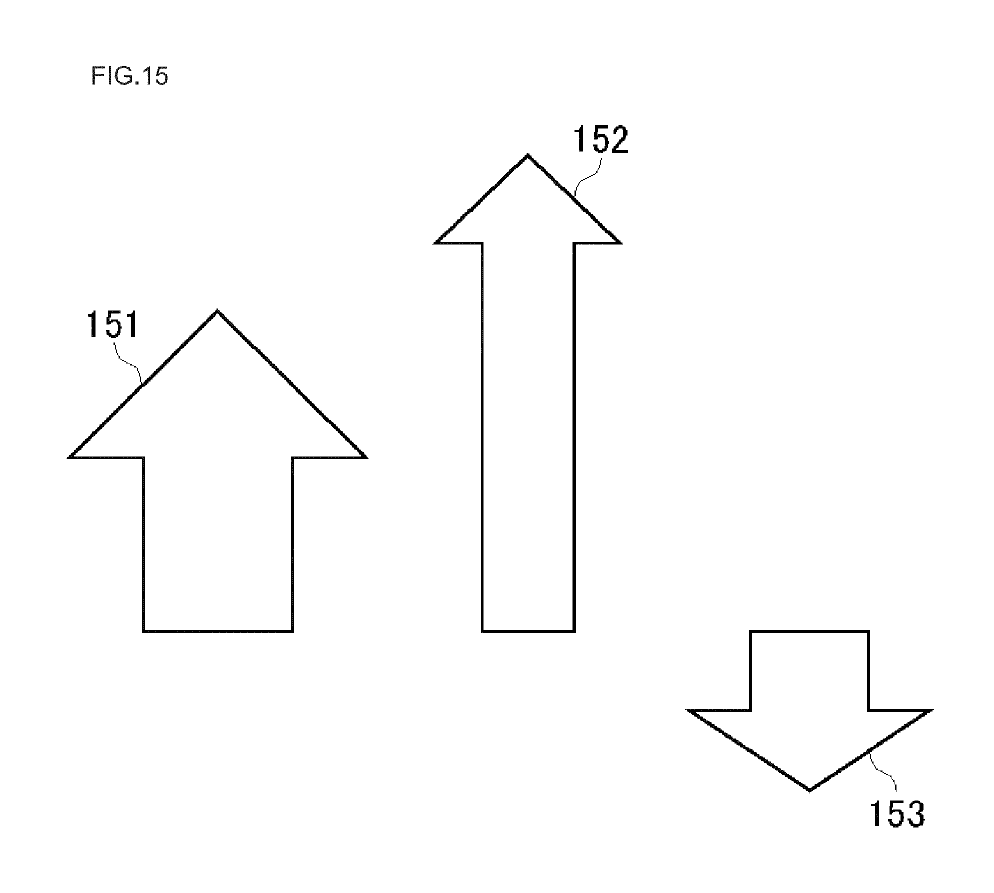

FIG. 15 is a diagram showing another example of the arrow. In the example, not only the arrow indicates that the available bandwidth has a tendency to increase when the arrow is pointing up, or that the available bandwidth has a tendency to decrease when the arrow is pointing down, but also the length of the arrow represents the strength of the tendency of the available bandwidth to increase and decrease (broaden and narrow), and the width of the arrow represents the current estimated bandwidth. In the example in FIG. 15: the arrow 151 represents that the current estimated bandwidth is relatively wide, and the available bandwidth has a tendency to increase, but the tendency is not very strong; the arrow 152 represents that the current estimated bandwidth is narrow, but the available bandwidth has a tendency to increase, and the tendency is relatively strong; and the arrow 153 represents that: the current estimated bandwidth is average, and the available bandwidth has a tendency to decrease, and the tendency is relatively weak.

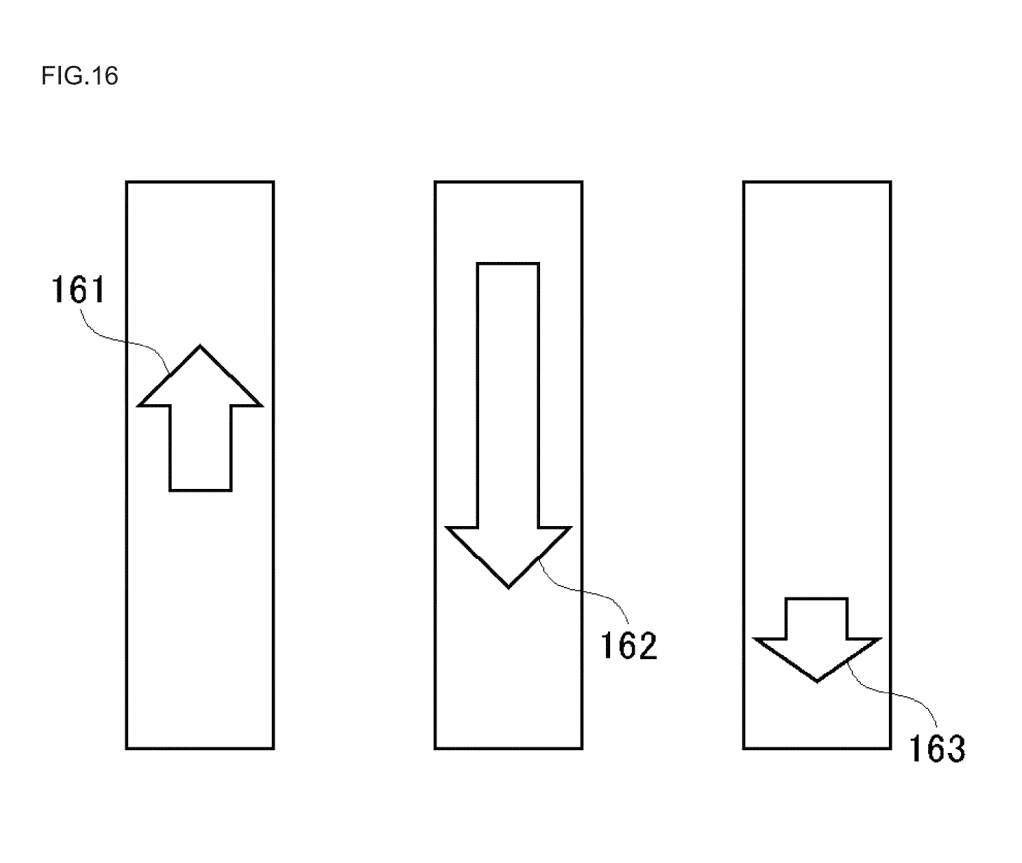

FIG. 16 is a diagram showing still another example of the arrow. In this example, not only the arrow indicates that the available bandwidth has a tendency to increase when the arrow is pointing up, or that the available bandwidth has a tendency to decrease when the arrow is pointing down, but also the length of the arrow represents the strength of the tendency of the available bandwidth to increase and decrease (broaden and narrow), and the starting position of the arrow represents the current estimated bandwidth. In the example in FIG. 16, a range-bar is displayed, so that the arrow can be displayed on the range-bar, to show the starting position clearly. In the example in FIG. 16: the arrow 161 represents that the current estimated bandwidth is average, and the available bandwidth has a tendency to increase, but the tendency is not very strong; the arrow 162 represents that the current estimated bandwidth is relatively wide, but the available bandwidth has a tendency to decrease, and the tendency is relatively strong; and the arrow 163 represents that: the current estimated bandwidth is relatively low, the available bandwidth has a tendency to decrease, and the tendency is relatively weak.

As described in the above examples, the current estimated bandwidth, the prediction of the tendency of the available bandwidth to increase and decrease, and the strength of the tendency toward increase and decrease are represented by the direction (pose), form (length and width), and position of the arrow. Furthermore, any of the current estimated bandwidth, the prediction of the tendency of the available bandwidth to increase and decrease, and the strength of the tendency toward increase and decrease may be expressed in colors. Such arrow may be used in the display screen in FIGS. 6, 7, 9 and the like.

### (Variation 9)

In the embodiment described previously, an example is provided in which the video taken by the wireless camera 10 is displayed on the central device 30. In this variation, the video taken by the wireless camera 10 may be displayed on an apparatus other than the central device 30, such as the wireless camera 10. In other words, an apparatus other than the central device 30 may have the display 31 to display the video taken by the selected wireless camera 10. In addition, the wireless camera 10 can have such display 31.

A currently-conceivable, desirable embodiment of the present technology has been described above. However, various modifications and alterations are possible as to the present embodiment. It is clearly understood that the appended claims encompass all such modifications and alterations which fall within the real spirit and scope of the present technology.

### INDUSTRIAL APPLICABILITY

By the present technology, since the amount of transmission data is limited for the wireless cameras having not been selected by a user of the central device, an available bandwidth to be used for radio transmission of transmission data is secured for the selected wireless camera. Consequently, the present technology is effective in that the transmission data from the selected wireless camera is transmitted to the central device at a high transmission rate, and is therefore utilized as a wireless camera system and the like having a plurality of wireless cameras and a central device.

What is claimed is:

1. A wireless camera system comprising a plurality of wireless cameras,
each of the wireless cameras comprising:
an image data generator configured to capture an image to generate image data;
a camera-side radio communicator configured to transmit transmission data containing the image data wirelessly; and
a camera controller configured to control operations of the wireless camera,
the wireless camera system comprising:
a camera selector configured to select a part of wireless cameras among the plurality of wireless cameras; and
a display configured to display the image data contained in the transmission data transmitted from the camera-side radio communicator in the wireless camera, depending on a selection made by the camera selector,
wherein the wireless camera system performs a process for preventing reduction in a transmission rate for the transmission data.

2. The wireless camera system according to claim 1, wherein the camera controller limits an amount of the transmission data of the wireless camera, as the process for preventing reduction in the transmission rate for the transmission data, when the wireless camera is not selected by the camera selector.

3. The wireless camera system according to claim 1, further comprising:
a band estimator configured to estimate an available bandwidth to be used by the camera-side radio communicator for radio communication of the transmission data; and
a band predictor configured to predict an available bandwidth for the wireless camera, based on an estimated value of the available bandwidth by the band estimator,
wherein the camera controller controls the wireless camera to issue a warning, as the process for preventing reduction in the transmission rate for the transmission data, when the band predictor predicts that the available bandwidth for the wireless camera is likely to decrease in a case where the wireless camera is selected by the camera selector.

4. The wireless camera system according to claim 1, further comprising:
a band estimator configured to estimate an available bandwidth to be used by the camera-side radio communicator for radio communication of the transmission data; and
a band predictor configured to predict an available bandwidth for the wireless camera, based on an estimated value of the available bandwidth by the band estimator,
wherein the display is configured to display a result of prediction obtained by the band predictor, as the process for preventing reduction in the transmission rate for the transmission data.

5. The wireless camera system according to claim 2, wherein
each of the plurality of wireless cameras is set a priority by a user of a central device, and
the controllers of the plurality of wireless cameras which have not been selected via the camera selector by the user of the central device limit the amounts of the transmission data of the unselected wireless cameras according to the priority of the wireless cameras.

6. The wireless camera system according to claim 5, wherein
when the wireless camera is not selected by the camera selector,
the camera controller limits the amount of the transmission data of the unselected wireless camera, when another wireless camera selected by the camera selector has a higher priority than the unselected wireless camera, and
the camera controller does not limit the amount of the transmission data of the unselected wireless camera, when another wireless camera selected by the camera selector has a higher priority than the unselected wireless camera.

7. The wireless camera system according to claim 2, wherein the camera controller limits the amount of the transmission data by changing a resolution of the image data.

8. The wireless camera system according to claim 2, wherein the camera controller limits the amount of the transmission data by changing a frame rate of the image data.

9. The wireless camera system according to claim 2, wherein the camera controller limits the amount of the transmission data by transmitting a still image only as the transmission data.

10. The wireless camera system according to claim 2, wherein the camera controller limits the amount of the transmission data by transmitting metadata of the image data only as the transmission data.

11. The wireless camera system according to claim 1, further comprising:
a band estimator configured to estimate an available bandwidth to be used by the camera-side radio communicator for radio communication of the transmission data; and
a band predictor configured to predict an available bandwidth for the wireless camera, based on an estimated value of the available bandwidth by the band estimator, wherein
the camera controller controls the wireless camera to issue a warning, as the process for preventing reduction in the transmission rate for the transmission data, when the band predictor predicts that the available bandwidth for the wireless camera is likely to decrease in a case where the wireless camera is selected by the camera selector.

12. The wireless camera system according to claim 1, further comprising:
a band estimator configured to estimate an available bandwidth to be used by the camera-side radio communicator for radio communication of the transmission data; and
a band predictor configured to predict an available bandwidth for the wireless camera, based on an estimated value of the available bandwidth by the band estimator, wherein
the display displays a result of prediction obtained by the band predictor of the wireless camera, as the process for preventing reduction in the transmission rate for the transmission data, the result of prediction being associated with image data from the wireless camera.

13. The wireless camera system according to claim 1, wherein the display is configured to display a display screen on which image data from the wireless camera selected by the camera selector is superimposed on a map image indicating locations of the plurality of wireless cameras.

14. The wireless camera system according to claim 13, wherein the display is configured to display a display screen on which a sign appears at a location of the wireless camera on the map image so as to indicate that the wireless camera is present.

15. The wireless camera system according to claim 13, wherein the display is configured to display image data of the wireless camera at the location of the wireless camera on the map image.

16. The wireless camera system according to claim 13, wherein the display is configured to display image data of the wireless camera, the image data being associated with the wireless camera in the map image.

17. A central device forming, together with a plurality of wireless cameras, a wireless camera system,
the central device being configured to perform a process for preventing reduction in a transmission rate for transmission data containing image data from each of the wireless cameras.

18. The central device according to claim 17, further comprising:
a band predictor configured to predict an available bandwidth for each of the wireless cameras, based on an estimated value of the available bandwidth to be used for transmission of transmission data containing image data from each of the wireless cameras wirelessly;
a camera selector for a user of the central device to select a part of wireless cameras from the plurality of wireless cameras; and
a central device-side radio communicator configured to transmit a control command to the wireless camera to cause the wireless camera to issue a warning, as the process for preventing reduction in the transmission rate for the transmission data, when the band predictor predicts that the available bandwidth for the wireless camera having been selected by the camera selector is likely to decrease.

19. The central device according to claim 17, further comprising a controller configured to display a result of prediction of an available bandwidth to be used for transmission of transmission data containing image data from the wireless camera by means of radio communication, as the process for preventing reduction in the transmission rate for the transmission data, the result of prediction being associated with image data from the wireless camera.

20. The central device according to claim 19, further comprising a band predictor configured to predict the available bandwidth for each of the wireless cameras, based on an estimated value of the available bandwidth to be used for transmission of transmission data containing image data from each of the wireless cameras wirelessly.

21. An image display method comprising:
a capturing step configured to captures an image to generate image data by each of a plurality of wireless cameras;
a transmission step configured to transmit transmission data containing the image data wirelessly from the wireless cameras;
a camera selection step configured to select a part of wireless cameras among the plurality of wireless cameras;
a display step configured to display the image data contained in the transmission data, depending on a selection made in the camera selection step; and
a processing step configured to prevent reduction in a transmission rate for the transmission data.

22. The image display method according to claim 21, wherein the processing process is configured to limits an amount of the transmission data of the wireless camera which is not selected in the camera selection step, as the process for preventing reduction in the transmission rate for the transmission data.

23. The image display method according to claim 21, further comprising:
a band estimation step configured to estimate an available bandwidth for radio communication of the transmission data by the transmission step; and
a band prediction step configured to predict an available bandwidth for the wireless camera, based on an estimated value of the available bandwidth by the band estimation step,
wherein the processing process is configured to control the wireless camera to issue a warning when the available bandwidth for the wireless camera which is not selected in the camera selection step is predicted to be likely to decrease in the band prediction step, as the process for preventing reduction in the transmission rate for the transmission data.

24. The image display method according to claim 21, further comprising:
a band estimation step configured to estimate an available bandwidth for radio communication of the transmission data by the transmission step; and
a band prediction step configured to predict an available bandwidth for the wireless camera, based on an estimated value of the available bandwidth by the band estimation step,
wherein the processing process is configured display a result of prediction obtained by the band prediction step, as the process for preventing reduction in the transmission rate for the transmission data, the result of prediction being associated with image data from the wireless camera.

25. An image display program to cause a computer of a central device forming, together with a plurality of wireless cameras, a wireless camera system, to function as a computer which performs a process for preventing reduction in a transmission rate for transmission data containing image data from each of the wireless cameras.

26. The image display program according to claim 25 to cause the computer to function further as:
a band predictor configured to predict an available bandwidth for each of the wireless cameras, based on an estimated value of the available bandwidth to be used for transmission of transmission data containing image data from each of the wireless cameras by means of radio communication; and
a controller configured to display a result of prediction obtained by the band predictor, as the process for preventing reduction in the transmission rate for the transmission data, the result of prediction being associated with image data from the wireless camera.

27. The image display program according to claim 25 to cause the computer to function further as
a controller configured to display a result of prediction of an available bandwidth to be used for transmission of the transmission data by the wireless camera wirelessly, as the process for preventing reduction in the transmission rate for the transmission data, the result of prediction being associated with image data from the wireless camera.
